(19) United States
(12) Patent Application Publication
(10) Pub. No.: US 2004/0021291 A1
(43) Pub. Date: Feb. 5, 2004

(54) Movable trailer hitch for avoiding pendulous movements in vehicle-trailer arrangements

(76) Inventors: Jurgen Haug, Frankfurt (DE); Ralf Seufert, Schmitten (DE); Martin Simeth, Konigstein (DE)

Correspondence Address: VENABLE, P.O. Box 34385, Washington, DC, 20043-9998, US

(21) Appl. No.: 10/207,000

(22) Filed: Jul. 30, 2002

(51) Int. Cl. B60D 1/00

(52) U.S. Cl. 280/455.1

(57) ABSTRACT

The invention relates to a method and an apparatus for stabilizing a vehicle-trailer arrangement having a movable trailer hitch, which is secured to the towing vehicle by a guide, and can be moved in the guide with a horizontal component, transversely to the longitudinal axis of the towing vehicle, by control members. A control device controls the movement of the trailer hitch corresponding to a control program that is implemented in the control device. The trailer hitch moves in the direction of the pendulous movement of the trailer drawbar, so the movement of the trailer hitch reduces the angle between the towing vehicle and the trailer drawbar when a pendulous movement occurs. This measure counteracts the pendulous movement of the trailer, and prevents the pendulous movement from building up within the physical limits of the system.

The invention relates to a product having the features of the independent claim.

Trailers towed by motor vehicles or trucks can be set into intense pendulous movements very easily, depending on their load and speed. These pendulous movements impede the driving stability of the vehicle combination, and lead to a critical situation that is difficult for the driver to control, often resulting in an accident.

Systems for controlling vehicle movement dynamics for individual vehicles are known, and are used in motor vehicles as ESPs (Electronic Stability Program) by BOSCH GmbH and DAIMLERCHRYSLER AG. A principle description of a vehicle-movement control appears in “Fahrsicherheitssysteme [Driving-Safety Systems]/Bosch,” Publisher: Robert Bosch GmbH, Second Updated and Expanded Edition, Vieweg, 1998. Accordingly, a system for controlling vehicle-movement dynamics includes a control program, which calculates the control commands for control elements of the associated control system from a control deviation between the desired vehicle behavior (driver's intention) and the actual behavior of the vehicle (handling), corresponding to a stored dynamic model that is characteristic of the vehicle. The dynamic model for the vehicle is determined experimentally in driving trials with the vehicle. The control strategy ensures that the vehicle follows the driving path (driver's intention) predetermined by the steering-wheel angle within the physical limits of the overall vehicle system. If it is possible that the physical limits of the vehicle will be exceeded, the vehicle-movement dynamics control system intervenes prohibitively.

Expanding on known vehicle-movement dynamics control systems, DE 197 08 144 A1 proposes a method for avoiding pendulous movements of a trailer towed by a motor vehicle, in which the drawbar wheels of the trailer are purposefully braked in order to generate an additional torque that counteracts the pendulous movement of the trailer. For this purpose, the trailer is provided with an autonomous vehicle-movement dynamics control system.

The drawback of this type of system is that, in fleets of motor vehicles, all trailers must be equipped with an independent vehicle-movement dynamics control system. Particularly in smaller trailers in the realm of recreational vehicles, which includes sport trailers, motor homes and small trailers that are towed by passenger vehicles, this leads to inordinately high investments that are unacceptably disproportionate to the value of the trailer.

In view of the above-described prior art, it is the object of the invention to stabilize trailers solely through measures implemented at the towing vehicle.

In accordance with the invention, this object is accomplished by the features of the independent claims. The dependent claims and the description disclose further, advantageous embodiments.

The solution involves a movable trailer hitch that is secured to the towing vehicle by a guide, and can be moved in the guide with a horizontal component, transversely to the longitudinal axis of the towing vehicle, by control members. A control device controls the movement of the trailer hitch corresponding to a control program that is implemented in the control device. The trailer hitch moves in the direction of the pendulous movement of the trailer drawbar, so the movement of the trailer hitch reduces the deflection of the trailer drawbar when a pendulous movement occurs. This measure counteracts the pendulous movement of the trailer, and prevents the pendulous movement from building up within the physical limits of the system.

With respect to the measuring sensor technology, several options exist. For example, an angle measurement can be performed at the drawbar of the trailer, then used to ascertain the deflection of the trailer relative to the imaginary extension of the longitudinal axis of the towing vehicle. This measured angle can then be incorporated into the control strategy of the control device as a control variable, depending on possible further movement variables of the towing vehicle. The angle-measurement device can comprise a sensor for measuring an angle of rotation, which is integrated directly into the coupling ball, or a distance sensor that is permanently mounted to the towing vehicle and operates contactless by means of radar, ultrasound or optically. The control strategy for suppressing the pendulous movements is in keeping with the principle of reducing the pendulum-swing amplitude of the trailer drawbar.

Another option for detecting the onset of a pendulous movement of the trailer lies in measuring the force exerted on the trailer hitch by the drawbar. As pendulous movements of the trailer are initiated, transverse forces occur at the trailer hitch, transversely to the direction of movement of the towing vehicle. These measured transverse forces can then be used as a control variable, as a function of further movement variables of the towing vehicle. The control strategy of the control device is then oriented toward counteracting the transverse forces, thereby minimizing the pendulous movement of the trailer.

ESP systems in the towing vehicle already employ transverse-acceleration sensors, so if the towing vehicle is already equipped with ESP, and if the ESP transverse-acceleration sensors are sufficiently sensitive, the ESP system of the towing vehicle can advantageously be used to detect the onset of a pendulous movement of the trailer. In the latter case, the transverse acceleration measured by the ESP transverse-acceleration sensor is used as a control variable for actuating the trailer hitch. The control is effected as a function of the steering-wheel angle and the dynamic model for the trailer so as to counteract control deviations between the driver's intention and the vehicle handling.

In ESP systems, the aforementioned transverse-acceleration sensor is generally characterized as a yaw-rate sensor. ESP systems in towing vehicles already employ yaw-rate sensors and steering-angle sensors, so if the towing vehicle is already equipped with ESP, the bending angle can be determined from the sensor signals of the steering-angle sensors and the yaw-rate sensor using a computerized vehicle model. Thus, it is possible to omit an additional bending-angle sensor.

As an alternative, the yaw-rate sensor can be used, in addition to a provided bending-angle sensor, to determine the necessary regulating direction. Here, a feedback can be created, which strongly damps the pendulous movement of the trailer. The pole-preset method is used to calculate the amplification of the respective controller feedback. Here, the amplifications are calculated such that the actual value of the pendulous movement assumes the desired value for the damping.

The invention primarily attains the following advantages:

With the invention, it is possible to expand existing vehicle-movement dynamics control systems of towing vehicles on vehicle-trailer arrangements. The control members of the trailer hitch are incorporated into the control system of the vehicle-movement dynamics control system of the towing vehicle, and the control program is tailored to a specific vehicle-trailer arrangement from computer simulations and driving trials with the arrangement. The suppression of pendulous movements between the towing vehicle and the trailer does not require a separate vehicle-movement dynamics control system for the trailer.

Typically, the vehicle-movement dynamics control systems of the towing vehicle store a plurality of control programs that are tailored to the respective vehicle type of the vehicle manufacturer. Then the associated, vehicle-specific control program is activated. Consequently, a proven vehicle-movement dynamics control system can be installed into different vehicle types, and the number of variations of the vehicle-movement dynamics control system can be kept small. The hitching of a trailer to a towing vehicle also influences and alters the dynamic handling of the towing vehicle. It is therefore advantageous for the towing operation and the non-towing operation of the towing vehicle to store two different control programs in the vehicle-movement dynamics control system of the towing vehicle, which are respectively optimized for the non-towing operation of the towing vehicle and for the towing operation of the towing vehicle.

A further advantage of the movable trailer hitch is the resulting slow, tight cornering of a vehicle-trailer arrangement. Here, with a purposeful deflection of the trailer hitch, it is possible to at least reduce the cutting of corners by the trailer. To prevent this cutting toward the inside of the curve, the trailer hitch or hitch ball is displaced toward the outside of the curve during slow, tight cornering. An active co-steering of the trailer hitch is only implemented with slow driving below a defined limit speed of the vehicle-trailer arrangement. This limit speed is specific to the respective vehicle-trailer arrangement, and is ascertained from driving trials. Likewise, a limit turning radius is determined from driving trials; if this value is not met, the power-steering function for the trailer hitch is activated. At least one of the two parameters of limit speed or limit turning radius must not be met in order for the power-steering function to be activated.

A further advantage of the trailer hitch according to the invention is that, with the trailer hitch, a plurality of different trailers can be stabilized by one and the same towing vehicle in towing operation. For each trailer to be hitched, a trailer-specific control program for the overall vehicle-trailer arrangement is advantageously stored in the vehicle-movement dynamics control system of the towing vehicle. Depending on the hitched trailer, the vehicle driver can select and activate the control program associated with the respective hitched trailer. Because the vehicle-movement dynamics control system continuously determines the data of the connected sensors on the towing vehicle during driving operation, it is also possible to establish an automatic trailer recognition through a computerized comparison of the measured sensor data with the stored parameters of the trailer-specific dynamic models. By suppressing the pendulous movements of the trailer drawbars, the trailer hitch according to the invention also permits the stabilization of arrangements whose trailers have no specific control program stored in the vehicle-movement dynamics control system. In this instance, a non-trailer-specific, standard control program is selected and activated for universal towing operation of the towing vehicle.

With the control members of the trailer hitch, it is possible to steer the trailer, to a limited extent, independently of the steering angle of the towing vehicle. This is a particularly significant advantage in shunting vehicle-trailer arrangements. During reverse driving, the arrangements rapidly become unstable. The steering angle at the front wheels of a towing vehicle also acts only on the rear axle of the vehicle itself before the steering movement is transmitted to the trailer. In other words, when arrangements are driven in reverse, disproportionately large steering angles in relation to the change in angle between the towing vehicle and the trailer are often necessary at the steering wheels of the towing vehicle in order to shunt the arrangement in the desired direction. The trailer hitch according to the invention remedies this situation by supporting the steering angle at the towing vehicle by actively co-steering the trailer hitch, corresponding to a control for driving in reverse. In this instance, the vehicle-movement dynamics control system employs a gear sensor that indicates the present gear of the towing vehicle. If the reverse gear is selected, and a trailer is hitched to the vehicle, a special control program for driving in reverse is selected and activated in the vehicle-movement dynamics control system.

Exemplary embodiments of the invention are illustrated in drawings and explained in detail below. Shown are in:

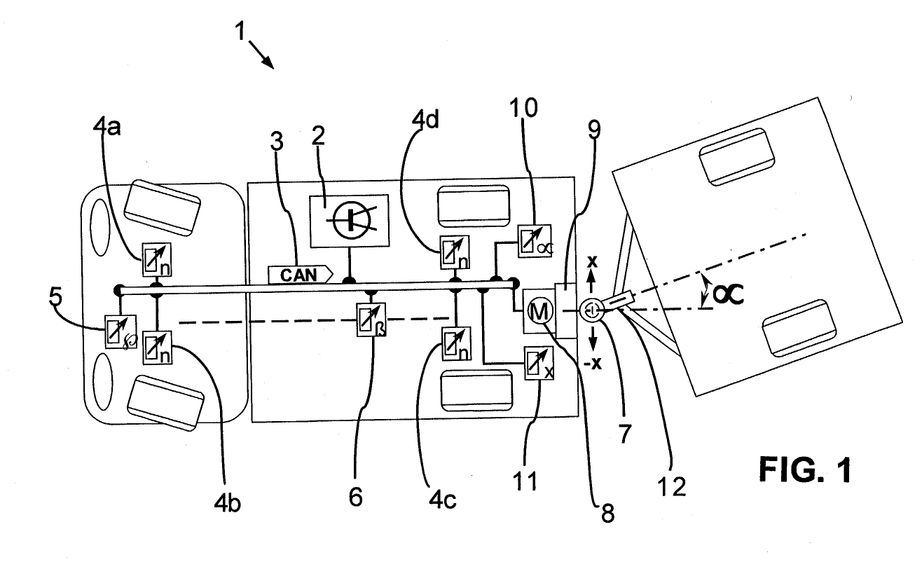

FIG. 1 a schematic representation of a trailer stabilization according to the invention, which is integrated into a towing vehicle having a vehicle-movement dynamics control system;

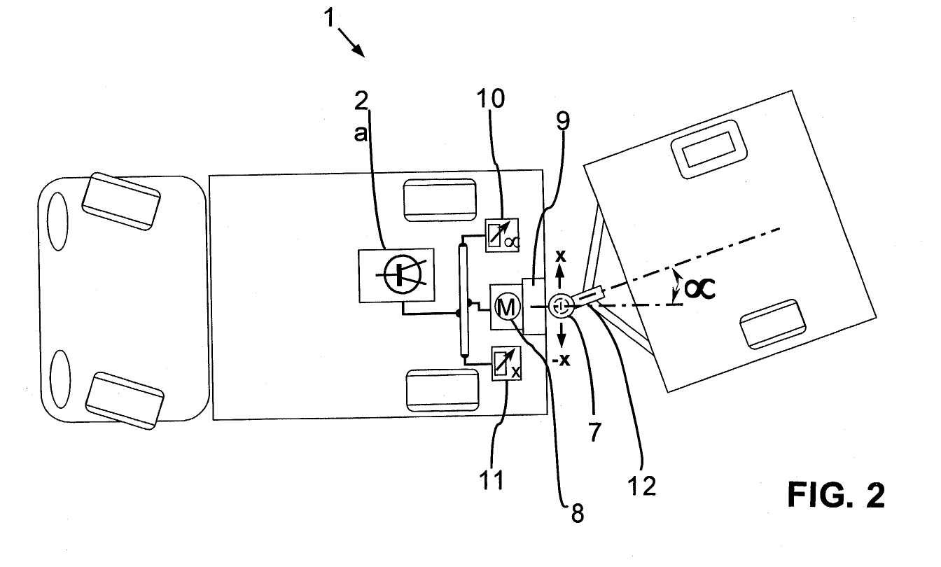

FIG. 2 a trailer stabilization according to the invention, as a retrofit kit for towing vehicles that have no vehicle-movement dynamics control system;

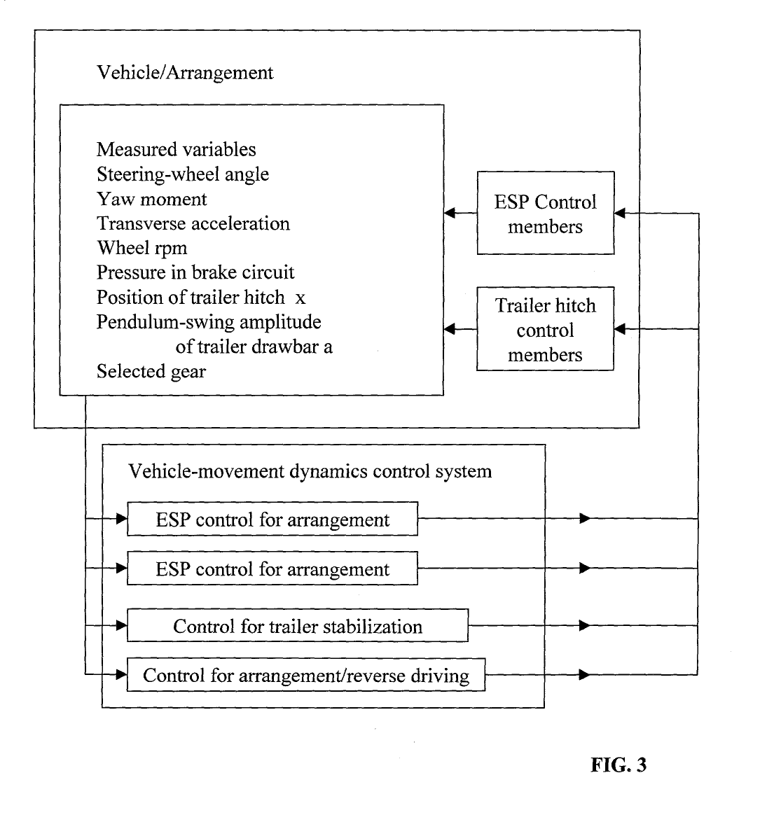

FIG. 3 a simplified block diagram of a vehicle-movement dynamics control system having input and output variables;

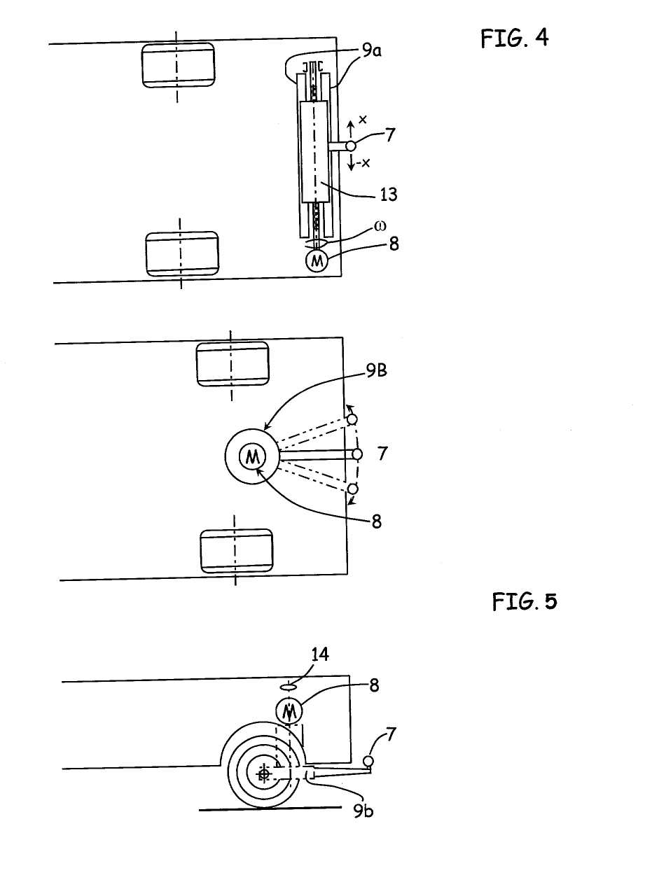

FIG. 4 an embodiment of the trailer stabilization in which the trailer hitch is seated on a linear guide;

FIG. 5 an embodiment of the trailer stabilization in which the trailer hitch is seated on a rotating guide having a vertical axis of rotation; and

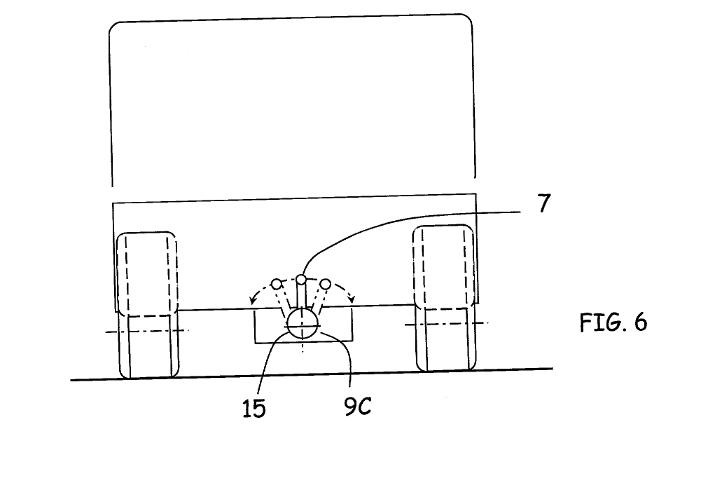

FIG. 6 an embodiment of the trailer stabilization in which the trailer hitch is seated on a rotating guide having a horizontal axis of rotation.

FIG. 1 is a schematic plan view of the trailer stabilization according to the invention, as it is integrated into, for example, a towing vehicle 1 that has been equipped in advance with ESP. In the vehicle, various measuring devices are connected via a linear bus structure 3 to a control device 2 of the vehicle-movement dynamics control system. Usually, the measuring devices of an ESP system are networked with one another via a known CAN (Controlled Area Network) bus. This CAN bus connects the control device to four wheel-rpm sensors 4a, 4b, 4c, 4d. An rpm sensor is mounted to each wheel of the towing vehicle. A steering-wheel angle sensor 5 measures the steering angle at the towing vehicle and transmits it to the control device via the CAN bus. A combined rate of rotation/transverse-acceleration sensor 6 measures the rate of rotation of the vehicle about its vertical axis, and accelerations that may occur transversely to the longitudinal axis of the vehicle. The combined rate of rotation/transverse acceleration sensor 6 is also often referred to as a yaw-moment sensor. The control members provided in an ESP system are not shown. An ESP system typically contains a hydraulic aggregate for actuating the wheel brakes, a control device for motor management, an advance-angle adjustment, a fuel injection element or an actuated throttle valve, also referred to as EGAS.

The trailer stabilization according to the invention expands an ESP system depicted, by way of example, with a trailer hitch 7, which is seated to move in a guide 9 by means of control members 8. In the embodiment illustrated in FIG. 1, the control member or members 8, also referred to as actuator(s), is or are connected to the control device 2 of the vehicle-movement dynamics control system of the towing vehicle. The trailer stabilization according to the invention further includes an angle sensor 10 and a position sensor 11. The angle sensor 10 measures the relative angle α between the longitudinal axis of the towing vehicle 1 and the longitudinal axis of the trailer drawbar 12. The position sensor measures the respective current position x of the trailer hitch 7 in the guide 9. The CAN bus of the vehicle on-board network likewise connects the angle sensor 10 and the position sensor 11 to the control device of the vehicle-movement dynamics control system. The control device stores the control parameters determined from simulations and driving trials for the respective arrangement formed by different towing vehicles and different trailers. The control device also stores the control programs for the arrangements, the towing vehicle alone, and for actuating the control members of the trailer hitch. The sub-controls are shown in greater detail in the block diagram of FIG. 3. The control strategy for suppressing the pendulous movements follows the principle of reducing the amplitude of the pendulum swing of the trailer drawbar, in accordance with which the trailer hitch follows in the direction of the amplitude of the pendulum swing, thereby reducing the angle between the longitudinal axis of the towing vehicle and the trailer drawbar. If the pendulous movement of the trailer drawbar has ceased due to this measure, the trailer hitch is returned to its initial position on the center line of the towing vehicle.

If the towing vehicle has no pre-mounted vehicle-movement dynamics control system, in an embodiment illustrated in FIG. 2, the trailer stabilization can be configured as a retrofit kit, also with a control device 2a provided especially for the trailer hitch. In this case, the control is limited to the actuation of the control members of the trailer hitch for suppressing pendulous movements of the trailer drawbar, according to the control strategy of the aforementioned embodiment illustrated in FIG. 1. This means that the control members 8 are actuated such that the trailer hitch 7 is moved in the guide 9 in the direction of the amplitude of the pendulum swing of the trailer drawbar.

The preferred embodiment is the integration of the trailer hitch into a complete system for controlling vehicle-movement dynamics in accordance with the embodiment of FIG. 1, because then an ESP vehicle-movement control of the vehicle-trailer arrangement is also possible.

FIG. 3 is a simplified block diagram of a vehicle-movement dynamics control system having an integrated trailer stabilization. The system to be controlled is the vehicle or the vehicle-trailer arrangement. Sensors measure different measurement values along this control system. The measurement values contain, in a never-ending enumeration, information pertaining to the steering-wheel angle, the yaw moment, the transverse acceleration, the wheel rpm, the braking pressure, the position of the trailer hitch, the amplitude of the pendulous movement of the trailer drawbar and the selected gear. The information is transmitted via a BUS, such as a CAN BUS, and constitutes the input variables for the vehicle movement dynamics control system, or, more precisely, for the control device of the vehicle-movement dynamics control system. The vehicle-movement controller encompasses a plurality of cascade arrangements of controllers that are used depending on the driving state of the vehicle, and depending on whether the vehicle is in towing or non-towing operation. The different controls are realized in software as partially highly complex control programs, and are stored in corresponding hardware modules in the control device of the vehicle-movement dynamics control system. The following are stored in the vehicle-movement dynamics controller as sub-controls: an ESP control for towing operation, an ESP control for the operation of the towing vehicle without a trailer, a control for trailer stabilization and a control for driving a vehicle-trailer arrangement in reverse, in which instance the trailer hitch serves as a power-steering element.

FIGS. 4 through 6 illustrate different embodiments for the guide in which the trailer hitch 7 can move. In principle, two different types of guides can be used for the trailer hitch: a linear guide or a rotating guide.

FIG. 4 schematically illustrates a linear guide for the trailer hitch 7. The trailer hitch is seated on two guide rails 9a with a sliding element 13, and can move back and forth at the vehicle end, transversely to the longitudinal axis of the vehicle. It is also possible to use, for example, in a never-ending enumeration, toothed-belt drives, rack-and-pinion gears, chain drives or a ball screw, for the linear drive of the vehicle sliding element, with each element being driven by an electrical motor. As an alternative, hydraulic or pneumatic drives in the form of actuating cylinders are also possible.

FIG. 5 depicts a trailer hitch 7, which is seated at the vehicle end with a rotating guide. The rotating guide has a vertical axis of rotation 14. The trailer hitch can be driven directly, or by means of an electrical motor coupled via gears to the axis of rotation. Linear drives linked to the rotating guide by levers may also be used as drives for the trailer hitch in the rotating guide. The trailer hitch can travel on a horizontal arc of a circle. The movement of the trailer hitch consequently has a horizontal component that is transverse to the longitudinal axis of the vehicle, and is therefore suited for compensating possible pendulous movements of a trailer drawbar.

FIG. 6 illustrates, again, an alternative embodiment of a rotating guide for the trailer hitch 7. In this embodiment, the axis of rotation 15 is oriented horizontally, parallel to the longitudinal axis of the vehicle. Its function is otherwise identical to that of the embodiment shown in FIG. 5.

1. An apparatus for stabilizing a vehicle-trailer arrangement, to whose vehicle a trailer is hitched via a trailer drawbar (12), the apparatus comprising:
a trailer hitch (7), which is seated to move by way of a guide (9) on the towing vehicle;
one or a plurality of control members (8), which is or are mechanically connected to the trailer hitch (7);
an angle sensor (10), which detects pendulous movements of the trailer drawbar (12);
one or a plurality of position sensors, which detects the current position of the trailer hitch (7) in the guide (9); and
a control device (2, 2a), which is connected via data lines (3) to the angle sensor (10), at least one position sensor (11) and at least one control member (8);
wherein the control device (2, 2a) stores at least one control program for actuating the control member(s) (8), and the trailer hitch (7) can travel in its guide (9) with the control member(s) (8) with a movement component that is transverse to the longitudinal axis of the towing vehicle.

2. The apparatus according to claim 1, in which the control device (2a) is a component of a vehicle-movement dynamics control system.

3. The apparatus according to claim 1 or 2, in which the data lines (3) are components of a linear bus system.

4. The apparatus according to claim 3, in which the bus system is a CAN bus.

5. The apparatus according to claim 2, in which numerous control programs are stored in the control device (2a).

6. The apparatus according to one of claims 1 through 5, in which the angle sensor (10) comprises a sensor for determining the angle of rotation, the sensor being disposed in the hitch ball.

7. The apparatus according to one of claims 1 through 5, in which the angle sensor comprises one or more contactless distance sensors.

8. The apparatus according to one of claims 1 through 5, in which the angle sensor comprises at least one force detector.

9. The apparatus according to one of claims 1 through 8, in which the guide (9) is a linear guide.

10. The apparatus according to one of claims 1 through 8, in which the guide (9) is a rotating guide having a vertical axis of rotation (14) or a horizontal axis of rotation (15) that is parallel to the longitudinal axis of the vehicle.

11. The use of an apparatus according to one of claims 1 through 10 for suppressing pendulous movements between the towing vehicle (1) and the trailer drawbar (12).

12. The use of an apparatus according to one of claims 1 through 10 as a power steering element for the trailer in order to at least reduce the cutting of the trailer toward the inside of the curve.

13. The use of an apparatus according to one of claims 1 through 10 as a power-steering element for driving vehicle-trailer arrangements in reverse.

14. A method for stabilizing a vehicle-trailer arrangement, to whose towing vehicle (1) a trailer is coupled by way of a trailer drawbar (12), and to whose towing vehicle an apparatus according to claim 1 is mounted, in which the trailer hitch (7) moves in the direction of the deflection (α) of the trailer drawbar (12), which reduces the deflection of the trailer drawbar when it performs pendulous movements.

15. The method according to claim 14, in which the apparatus according to claim 1 is integrated into an existing vehicle-movement dynamics control system of the towing vehicle.

16. The method according to claim 14, in which an angle sensor detects pendulous movements of the trailer drawbar.

17. The method according to claim 14, in which at least one contactless distance sensor detects pendulous movements of the trailer drawbar.

18. The method according to claim 14, in which a force detector detects pendulous movements of the trailer drawbar.

19. A vehicle-movement dynamics control system for vehicle-trailer arrangements comprising a towing vehicle and a trailer, which is provided with an ESP system comprising:
a control device (2), which is connected via data lines (3) to measurement devices (4a, 4b, 4c, 4d) for the wheel rpm, and has a steering-wheel-angle sensor (5) with a yaw moment sensor (6), and control members for actuating the wheel brakes of the towing vehicle;
one or more control programs for actuating the connected control members, wherein the control device stores the control program(s), which uses or use a control deviation between the intended vehicle behavior (driver's intention) and the actual vehicle behavior (handling) to calculate the control commands for the connected control members, corresponding to a dynamic model that is characteristic of the vehicle,
characterized in that at least one control member (8) for actuating a movable trailer hitch (7) is integrated into the control system of the vehicle-movement dynamics control system, at least one measuring device (10) for detecting pendulous movements of the trailer drawbar and at least one measuring device (11) for detecting the position of the trailer hitch (7) are connected to the control device (2), and the trailer hitch (7) moves with a component that is transverse to the longitudinal axis of the towing vehicle.

20. The vehicle-movement dynamics control system according to claim 19, characterized in that the control device (2) of the vehicle-movement dynamics control system stores a plurality of trailer-specific control programs.

21. The vehicle-movement dynamics control system according to claim 19, characterized in that the control device (2) stores at least one non-trailer-specific, standard control program.

22. The use of a vehicle-movement dynamics control system according to claim 19 for suppressing pendulous movements of the trailer drawbar (12) at the trailer hitch (7).

23. The use of a vehicle-movement dynamics control system according to claim 19 as a power-steering element for the trailer in order to at least reduce the cutting of the trailer toward the inside of the curve during cornering.

24. The use of a vehicle-movement dynamics control system according to claim 19 as a shunting element when driving vehicle-trailer arrangements in reverse.
